(19) United States
(12) Patent Application Publication
(10) Pub. No.: US 2013/0155846 A1
(43) Pub. Date: Jun. 20, 2013

(54) Active Standby Virtual Port-Channels

(71) Applicants: Gayatri Ramachandran, Sunnyvale, CA (US); Chandan Mishra, Sunnyvale, CA (US); Smita Rai, Mountain View, CA (US); Sanjay Sane, Fremont, CA (US)

(72) Inventors: Gayatri Ramachandran, Sunnyvale, CA (US); Chandan Mishra, Sunnyvale, CA (US); Smita Rai, Mountain View, CA (US); Sanjay Sane, Fremont, CA (US)

(21) Appl. No.: 13/330,274

(22) Filed: Dec. 19, 2011

(51) Int. Cl. H04L 12/26; H04L 12/28

(52) U.S. Cl. 370/225; 370/254; 370/242

(57) ABSTRACT

An active-standby virtual port channel mechanism may be provided, where at any point only one virtual port channel link would be active. Upon failover of the active, a fast failover mechanism is employed to move active traffic to a standby port channel link.

### BACKGROUND

In some data center networks, customers may desire a feature such as active standby virtual port channels. While prior systems allowed for Link Aggregation Control Protocol (“LACP”) hot standby ports, these solutions may fail if there is no spanning tree operational on the virtual port channels. Such prior systems may also be insufficient when the ports are used to connect to a Multiprotocol Label Switching (“MPLS”) cloud, where only one port channel should normally be accepting and forwarding traffic with the standby port channel ready to take over. It is desired that the convergence loss is minimal when an active port channel fails and a standby port channel takes over.

These problems cannot be solved by simply applying the LACP protocol, as LACP requires the end points of any member interface to be between the same two switches. These two ports connecting the L2 layer to the MPLS cloud may commonly be between two different pairs of switches. As such there is a need for the creation of active standby virtual port channels. Specifically, there is a need to achieve a fast failover, with the semantics of a hot standby protocol (such as LACP) for a port-channel crossing two different switches.

### BRIEF DESCRIPTION OF THE DRAWINGS

The accompanying drawings, which are incorporated in and constitute a part of this disclosure, illustrate various embodiments. In the drawings:

FIG. 1 is an illustration of an example operating environment;

FIG. 2 is an illustration of an operating environment for embodiments described herein;

FIG. 3 is a flow chart of embodiments of the present disclosure;

FIG. 4 is a flow chart of embodiments of the present disclosure;

FIG. 5 is a block diagram of a network computing device.

### DESCRIPTION OF EXAMPLE EMBODIMENTS OVERVIEW

Consistent with embodiments of the present disclosure, systems and methods are disclosed for active-standby virtual port channel mechanism, where at any point only one virtual port channel link is active. Upon failover of the active, a fast failover mechanism is employed to move active traffic to a standby port channel link.

It is to be understood that both the foregoing general description and the following detailed description are examples and explanatory only, and should not be considered to restrict the application's scope, as described and claimed. Further, features and/or variations may be provided in addition to those set forth herein. For example, embodiments of the present disclosure may be directed to various feature combinations and sub-combinations described in the detailed description.

### DETAILED DESCRIPTION

The following detailed description refers to the accompanying drawings. Wherever possible, the same reference numbers are used in the drawings and the following description to refer to the same or similar elements. While embodiments of this disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Prior art systems have been applied to achieve single-control plane virtual port channels, meant for a single-chassis. The active link and the standby links have to be within the gamut of a single control plane. Embodiments of the present disclosure achieve active-standby vPC by 2 distinct chassis. Specifically, embodiments of the present disclosure employ distributed control planes, with active and standby links across 2 different chassis.

Furthermore, prior art systems required the configuration of each access switch to achieve an active-standby virtual port channel. In embodiments of the present disclosure, the only configuration needed on the access switch is to make all uplinks correspond to a port-channel. The active-standby property needs only to be configured only on the two virtual port channel switches.

Embodiments of the present disclosure reduce the effect of convergence impact. In prior art systems, a MAC address Move update (“MMU”) message was needed to be generated upon each failure. Furthermore, the upstream switch is required to handle the MMU. Only then it can failover be handled. So, all switches need to source/sink such control plane packets in such prior art systems. In present embodiments, for virtual port channels, no such additional control plane packet overhead is needed. Only the two virtual port channel switches communicate link failure from one chassis to other chassis. The remaining switches have no need to source/sink any other control plane packets.

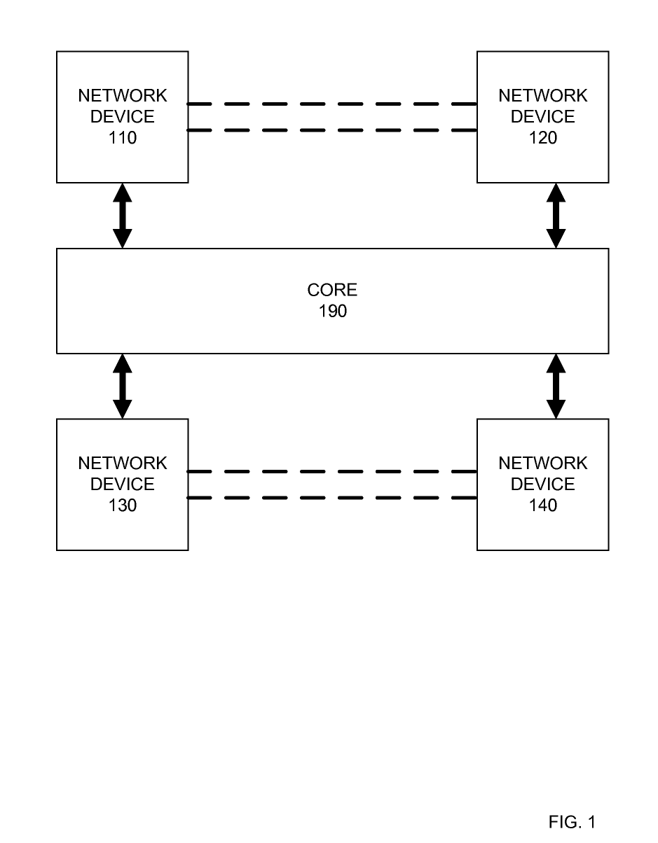

FIG. 1 illustrates an example network topology for a network 100. Network device 110, for example, may be a data center class switching device connecting a data center to a core 190. In some embodiments, core 190 may be a MPLS cloud core. Similar to network device 110, network device 120, network device 130, and network device 140 may all be in communication with one another through core 190 or through a direct link. Each network device may have a direct communications link to core 190.

In the topology depicted by FIG. 1, if there is not end-to-end spanning tree protocol (“STP”) running on the network 100, a loop may be formed in the network. Embodiments of the present disclosure propose solutions for this problem using the present virtual port channel infrastructure.

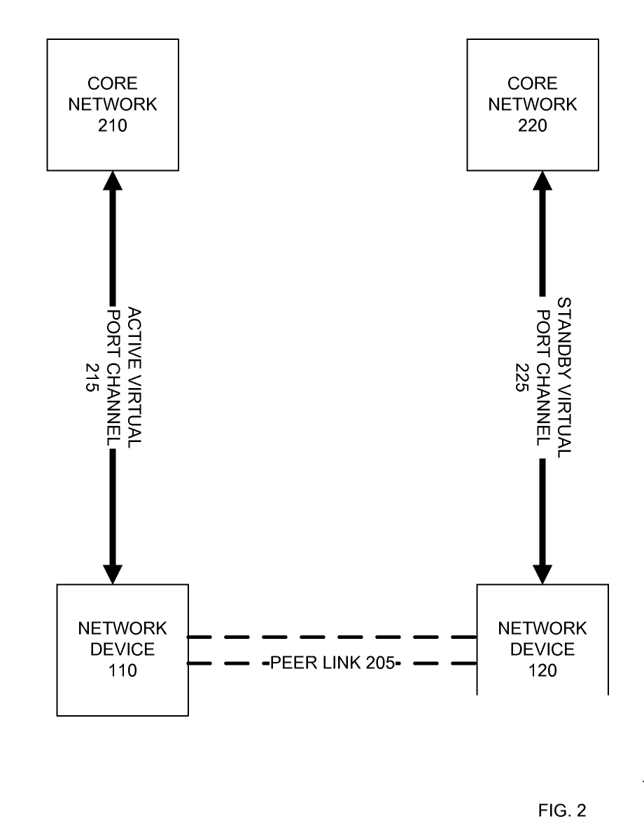

FIG. 2 illustrates an example network for implementation of embodiments of the present disclosure. Here, network device 110 and network device 120 may be in communication over a peer link 205. Network device 110 may also be in communication with a core 210 through a virtual port channel 215. Similarly, network device 120 may also be in communication with a core 220 through a virtual port channel 225. In some embodiments, virtual port channel 215 may be designated as the active port channel and virtual port channel 225 may be designated as the standby port channel.

In embodiments of the present disclosure, when virtual port channel 225 is acting as the standby port channel, virtual port channel 225 should not accept or forward out any packet, even if the port is up. When a port is configured as a standby virtual port channel from a command-line interface (“CLI”), all of the VLANs associated with peer link 205 may be blocked through color blocking logic (“CBL”).

If the active leg (virtual port channel 215) goes down, the standby leg (virtual port channel 225) may immediately take over forwarding and accepting packets on the associated VLANs. This approach may help to minimize convergence loss.

The ports may be forwarding from both core 210 and core 220's perspective. As such, it is the designated standby virtual port channel which may be filtering multi-destination packets. Since the standby virtual port channel 225 sends out no traffic, core 220 may never learn any of the associated MAC address information of the multi-destination packets travelling through it. Similarly, core 220 will not forward any unicast traffic on it.

Embodiments of the present disclosure may require MAC synchronization on the virtual port channel peers and local target logic (“LTL”) redirection over peer-link 225 for correct forwarding as well as fast convergence. MAC synchronization may be accomplished when an address is learned by virtual port channel 215 for one of the peer network devices. Layer-2 Forwarding Messages (“L2FM”) may be employed to synchronize across the chassis, and attach the address to a virtual port channel on a remote peer network device.

When a virtual port channel is on standby, the LTL for the virtual port channel may be made to point to the peer-link members instead of the member links of the virtual port channel. This may help to ensure that all packets meant to be forwarded over the virtual port channel on standby will be redirected to the peer link.

Referring back to FIG. 2, in some embodiments, both virtual port channel 215 (active) and virtual port channel 225 (standby) may be operating. If traffic for a destination host behind the core cloud lands on network device 120, the traffic should egress out of the virtual port channel on the active leg. To ensure this, MAC synchronization is required so that all of the hosts learnt by network device 110 over the virtual port channel are added on network device 120 as well. Furthermore, on network device 110, LTL redirection may be used to redirect all packets destined to the virtual port channel over peer link 205. Until the VLANs are suspended on the standby virtual port channel leg, no packets will be accepted or forwarded on that port.

When the active leg of the virtual port channel goes down, the standby leg should take over with minimal convergence loss. The MAC synchronization and LTL redirection serve to help reduce this loss. As soon as the active link fails, MCECM on the standby leg should disassociate the virtual port channel from the peer link 205. As such, the packets destined for the virtual port channel will no longer be redirected over peer link 205. Furthermore, all the CBL blocked VLANs should be made available for forwarding. The MAC addresses in the core must be updated at this point using an appropriate mechanism, such as a MAC resolver update.

While the virtual port channel is tracking peer-link 205 on the standby leg (traffic is getting redirected over the peer-link), Private Internet Exchange (“PIXM”) support may be required to cache a PCM network device's request for a modification of the local target logic (“modify member ltl”). On the standby, while the virtual port channel is tracking the peer-link (i.e. traffic is getting redirected over peer-link 205), PIXM support may be required to cache the PCM network device's request for “modify member ltl”. Moreover, PIXM may reject the CBL request on a tracked port-channel. PIXM also may need to cache the state from the STP, since this is a tracked port-channel. Upon failover, PIXM may need to apply the “modify member ltl” and the CBL state, when the virtual port channel is dissociated by MCECM on failover conditions.

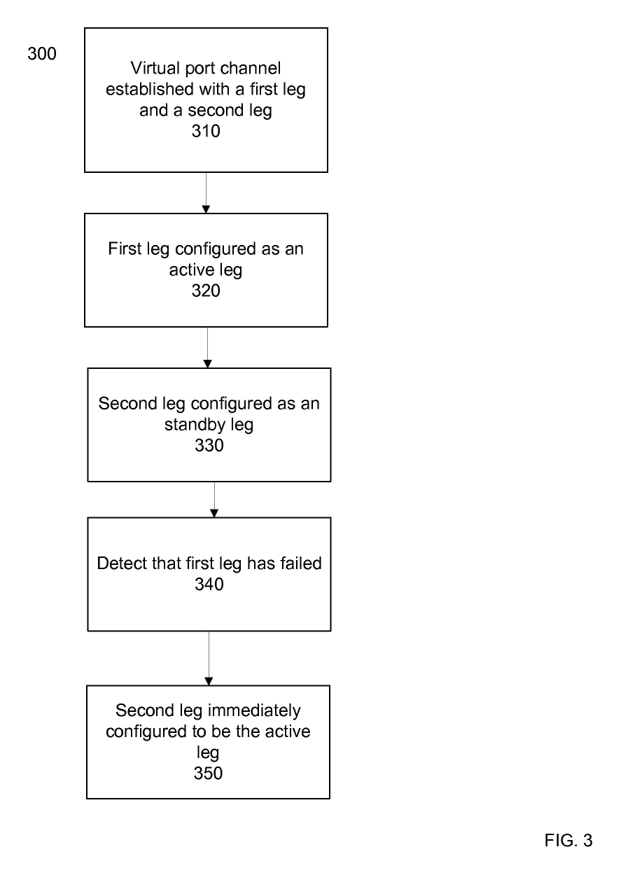

FIG. 3 is a flow chart illustrating embodiments of the present disclosure. Method 300 may begin at step 310. At step 310, a virtual port channel may be established with a first leg and a second leg. The first leg and the second leg may be on separate chassis and associated with separate network devices, such as switch devices associated with the virtual port channel. Method 300 may then proceed to step 320 where the first leg may be configured as an active leg. By configuring a leg as active, it designates which of the two legs associated with the virtual port channel is available for the forwarding of traffic.

Similarly, method 300 may advance to step 330. At step 330 the second leg may be configured as a standby leg. The designated standby leg may not accept or forward transmitted packets. As part of the configuration process, all VLANs that are part of a peer link connecting the first leg and the second leg may be blocked. In some embodiments, this may be accomplished through CBL blocking.

Method 300 may then proceed to step 340. At step 340, it may be detected that the first leg has failed. The active leg could fail for a number of reasons and detection may be achieved by any suitable approach. When it is detected that the active leg has failed, method 300 may proceed to step 350. At step 350, the second leg may be immediately configured to be the active leg. MAC synchronization messages may then be sent to a plurality of peer network devices to provide address information for the modified virtual port channel.

As such, when subsequent traffic is received the packets may be accepted and forwarded to the second leg, which is now acting as the active leg of the virtual port channel. The MAC address of a switch device associated with the active leg may be learned and employed to ensure proper traffic forwarding. As part of the transition from active to standby and vice versa, the local target logic should be configured for the switch device associated with the active leg and the switch device associated with the standby leg.

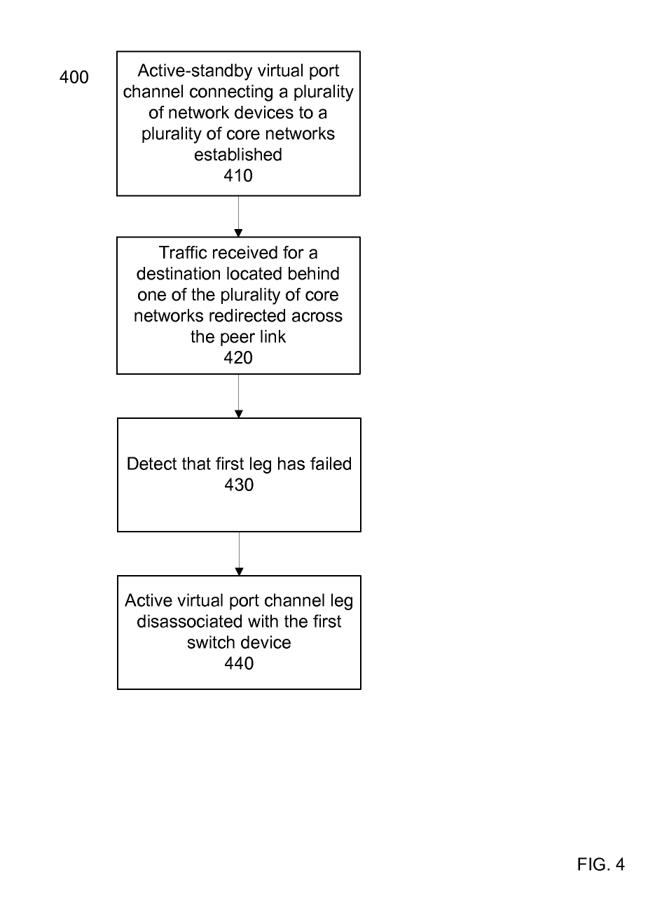

FIG. 4 is a flow chart illustrating embodiments of the present disclosure. Method 400 may begin at step 410. At step 410, a virtual port channel connecting a plurality of network devices to a plurality of core networks may be established. The virtual port channel may comprises 1) an active virtual port channel leg associated with a first switch device or other appropriate network device and 2) a standby virtual port channel leg associated with a second switch device. In some embodiments, the first switch device and the second switch device may be connected across a peer link.

Method 400 may proceed to step 420 where traffic may be received for a destination located behind one of the plurality of core networks. All traffic destined for the first switch device may be redirected across the peer link to the second switch device. In some embodiments, the traffic may be egressed to the active virtual port channel leg when received at a standby virtual port channel leg.

At step 430, a failure of the active virtual port channel may be detected. The detected failure may advance method 400 to step 440. At step 440 the active virtual port channel leg may be disassociated with the first switch device. To that effect, all hosts learned by a first network device may be added to the switch devices such that associating the active port channel leg with the second switch device

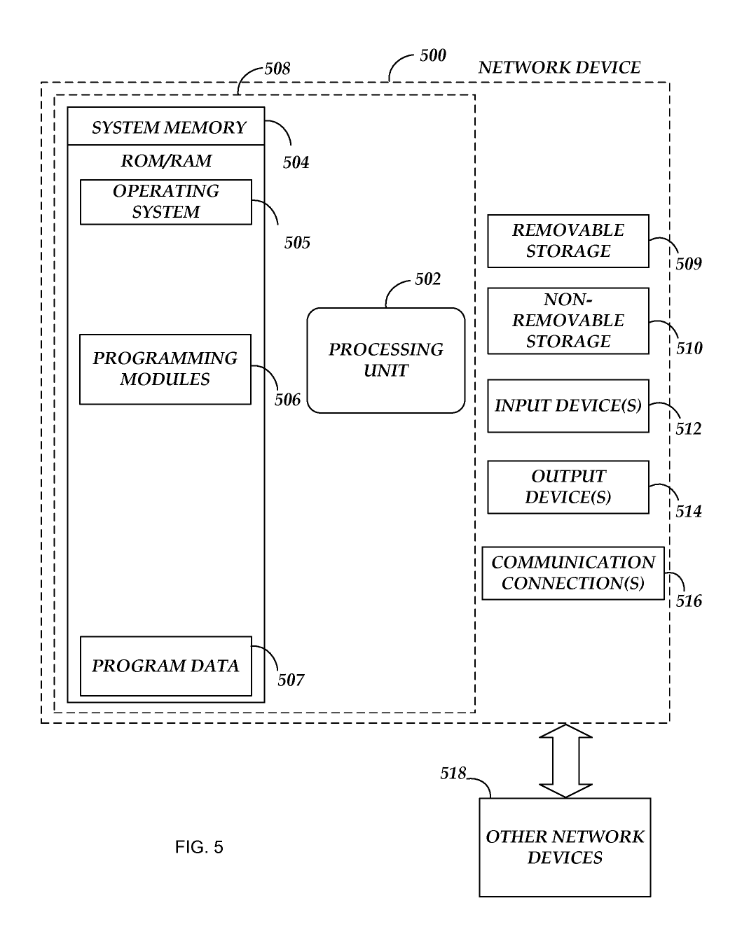

FIG. 5 is a block diagram of a system including network device 500. Consistent with embodiments of the present disclosure, the aforementioned memory storage and processing unit may be implemented in a network device, such as network device 500 of FIG. 5. Any suitable combination of hardware, software, or firmware may be used to implement the memory storage and processing unit. For example, the memory storage and processing unit may be implemented with network device 500 or any of other network devices 518, in combination with network device 500. The aforementioned system, device, and processors are examples and other systems, devices, and processors may comprise the aforementioned memory storage and processing unit, consistent with embodiments of the present disclosure.

With reference to FIG. 5, a system consistent with embodiments of the present disclosure may include a network device, such as network device 500. In a basic configuration, network device 500 may include at least one processing unit 502, a secure processing unit for decryption 520, and a system memory 504. Depending on the configuration and type of network device, system memory 504 may comprise, but is not limited to, volatile (e.g., random access memory (RAM)), non-volatile (e.g., read-only memory (ROM)), flash memory, or any combination. System memory 504 may include operating system 505, one or more programming modules 506, and may include program data 507. Operating system 505, for example, may be suitable for controlling network device 500's operation. Furthermore, embodiments of the present disclosure may be practiced in conjunction with a graphics library, other operating systems, or any other application program and is not limited to any particular application or system. This basic configuration is illustrated in FIG. 5 by those components within a dashed line 508.

Network device 500 may have additional features or functionality. For example, network device 500 may also include additional data storage devices (removable and/or non-removable) such as, for example, magnetic disks, optical disks, or tape. Such additional storage is illustrated in FIG. 5 by a removable storage 509 and a non-removable storage 510. Computer storage media may include volatile and nonvolatile, removable and non-removable media implemented in any method or technology for storage of information, such as computer readable instructions, data structures, program modules, or other data. System memory 504, removable storage 509, and non-removable storage 510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by network device 500. Any such computer storage media may be part of device 500. Network device 500 may also have input device(s) 512 such as a keyboard, a mouse, a pen, a sound input device, a touch input device, etc. Output device(s) 514 such as a display, speakers, a printer, etc. may also be included. The aforementioned devices are examples and others may be used.

Network device 500 may also contain a communication connection 516 that may allow device 500 to communicate with other network devices 518, such as over a network in a distributed network environment, for example, an intranet or the Internet. Communication connection 516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 504, including operating system 505. While executing on processing unit 502 or secure processing unit for decryption 520, programming modules 506 may perform processes including, for example, one or more method 200, 300, and 400's stages as described above. The aforementioned process is an example; processing unit 502 and secure processing unit for decryption 520 may perform other processes.

Generally, consistent with per-subscriber stream management according to embodiments of this invention, program modules may include routines, programs, components, data structures, and other types of structures that may perform particular tasks or that may implement particular abstract data types. Moreover, embodiments may be practiced with other computer system configurations, including hand-held devices, multiprocessor systems, microprocessor-based or programmable consumer electronics, minicomputers, mainframe computers, and the like. Embodiments of the present disclosure may also be practiced in distributed network environments where tasks are performed by remote processing devices that are linked through a communications network. In a distributed network environment, program modules may be located in both local and remote memory storage devices.

Furthermore, embodiments of the present disclosure may be practiced in an electrical circuit comprising discrete electronic elements, packaged or integrated electronic chips containing logic gates, a circuit utilizing a microprocessor, or on a single chip containing electronic elements or microprocessors. Embodiments may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present disclosure, for example, may be implemented as a computer process (method), a network system, or as an article of manufacture, such as a computer program product or computer readable media. The computer program product may be a computer storage media readable by a computer system and encoding a computer program of instructions for executing a computer process. The computer program product may also be a propagated signal on a carrier readable by a network system and encoding a computer program of instructions for executing a computer process. Accordingly, aspects may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of per-subscriber stream management. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the present disclosure have been described, other embodiments may exist. Furthermore, although embodiments have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the present disclosure.

What is claimed is:

1. A method comprising:
establishing a virtual port channel with a first leg and a second leg;
configuring the first leg as an active leg; and
configuring the second leg as a standby leg, wherein the standby leg does not accept or forward transmitted packets.

2. The method of claim 1, further comprising blocking all VLANs that are part of a peer link connecting the first leg and the second leg.

3. The method of claim 2, wherein the blocking is CBL blocking.

4. The method of claim 1, further comprising detecting that the first leg has failed; and
immediately configuring the second leg as the active leg.

5. The method of claim 4, further comprising sending MAC synchronization messages to a plurality of peer network devices.

6. The method of claim 5, further comprising:
accepting one or more packets previously handled by the first leg; and
forwarding the one or more packets to the second leg.

7. The method of claim 6, further comprising: learning the MAC address of a switch device associated with the active leg.

8. The method of claim 3, further comprising configuring the local target logic for a first switch device associated with the active leg and a second switch device associated with the standby leg.

9. A method comprising:
establishing a virtual port channel connecting a plurality of network devices to a plurality of core networks, wherein the virtual port channel comprises:
an active virtual port channel leg associated with a first switch device; and
a standby virtual port channel leg associated with a second switch device, wherein the first switch device and the second switch device are connected across a peer link.

10. The method of claim 9, further comprising receiving traffic for a destination located behind one of the plurality of core networks.

11. The method of claim 10, further comprising redirecting all packets in the traffic destined for the first switch device across the peer link.

12. The method of claim 11, further comprising egressing the traffic to the active virtual port channel leg.

13. The method of claim 9, further comprising:
determining a failure of the active virtual port channel;
disassociating the active virtual port channel leg with the first switch device; and
adding all hosts learned by a first network device.

14. The method of claim 13, further comprising associating the active port channel leg with the second switch device.

15. An apparatus comprising:
a memory; and
a processor, wherein the processor is configured to:
maintain a status indicating that a leg associated with the virtual port channel and the apparatus is one of: active or standby;
detect a failure when the leg associated with the virtual port channel and the apparatus is active;
communicate with a switch device associated with a virtual port channel across a peer link when a failure of the active leg.

16. The apparatus of claim 15, wherein the apparatus is located on one of a plurality of distributed control planes.

17. The apparatus of claim 16, wherein the processor is further configured to change the associated leg status from active to standby.

18. The apparatus of claim 17, wherein the processor is further configured to:
forward received traffic to the switch device.

19. The apparatus of claim 18, wherein the processor is further configured to:
add hosts learned by the switch device.

20. The apparatus of claim 15, wherein the switch device and the apparatus are located of separate chassis.
